(19) United States
(12) Patent Application Publication
(10) Pub. No.: US 2004/0198602 A1
(43) Pub. Date: Oct. 7, 2004

(54) Thermographic materials containing metal oxide conductive layers

(75) Inventor: Oanh V. Pham, Maplewood, MN (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/408,393

(22) Filed: Apr. 7, 2003

(51) Int. Cl. B41M 5/30

(52) U.S. Cl. 503/212

(57) ABSTRACT

Non-photosensitive thermographic materials have a support and thermally sensitive imaging layer(s) and an outermost conductive layer on either or both sides of the support. The outermost conductive layer comprises non-acicular metal antimonate particles dispersed in a hydrophobic binder and is provided from a non-aqueous solvent-based formulation.

### FIELD OF THE INVENTION

This invention relates to thermographic materials containing certain metal oxide conductive layers. In particular, the invention relates to thermo-graphic materials containing metal antimonate conductive particles in outermost conductive layers on either or both sides of the support. The invention also relates to methods of imaging the thermographic materials.

### BACKGROUND OF THE INVENTION

Silver-containing thermographic imaging materials are non-photo-sensitive materials that are used in a recording process wherein images are generated by the use of thermal energy. These materials have been known in the art for many years and generally comprise a support having disposed thereon (a) a relatively or completely non-photosensitive source of reducible silver ions, (b) a reducing composition (usually including a developer) for the reducible silver ions, and (c) a suitable hydrophilic or hydrophobic binder.

In a typical thermographic construction, the image-forming layers are based on silver salts of long chain fatty acids. Typically, the preferred non-photosensitive reducible silver source is a silver salt of a long chain aliphatic carboxylic acid having from 10 to 30 carbon atoms. The silver salt of behenic acid or mixtures of acids of similar molecular weight are generally used. At elevated temperatures, the silver of the silver carboxylate is reduced by a reducing agent for silver ion such as methyl gallate, hydroquinone, substituted-hydroquinones, hindered phenols, catechols, pyrogallol, ascorbic acid, and ascorbic acid derivatives, whereby an image of elemental silver is formed. Some thermographic constructions are imaged by contacting them with the thermal head of a thermographic recording apparatus such as a thermal printer or thermal facsimile. In such constructions, an anti-stick layer is coated on top of the imaging layer to prevent sticking of the thermographic construction to the thermal head of the apparatus utilized. The resulting thermographic construction is then heated to an elevated temperature, typically in the range of from about 60 to about 225° C., resulting in the formation of an image.

The non-photosensitive source of reducible silver ions is a material that contains reducible silver ions. Typically, the preferred non-photosensitive source of reducible silver ions is a silver salt of a long chain aliphatic carboxylic acid having from 10 to 30 carbon atoms, or mixtures of such salts. Such acids are also known as “fatty acids” or “fatty carboxylic acids.” Silver salts of other organic acids or other organic compounds, such as silver imidazoles, silver tetrazoles, silver benzotriazoles, silver benzotetrazoles, silver benzothiazoles and silver acetylides may also be used. U.S. Pat. No. 4,260,677 (Winslow et al.) discloses the use of complexes of various inorganic or organic silver salts.

Problem to be Solved

Many of the chemicals used to make supports or supported layers in thermographic materials have electrically insulating properties, and electrostatic charges frequently build up on the materials during manufacture, packaging, and use. The accumulated charges can cause various problems.

Build-up of electrostatic charge can cause sheets of imageable material to stick together causing misfeeds and jamming within processing equipment. Additionally, accumulated electrostatic charge can attract dust or other particulate matter to the thermographic material, thereby requiring more cleaning means so transport through the processing equipment and image quality of the material are not diminished.

Build-up of electrostatic charge also makes handling of developed sheets of imaged material more difficult. For example, a radiologist desires a static free sheet for viewing on light boxes. This problem can be particularly severe when reviewing an imaged film that has been stored for a lengthy period of time because many antistatic materials loose their effectiveness over time.

In general, electrostatic charge is related to surface resistivity (measured in ohm/sq) and charge level. While electrostatic charge control agents (or antistatic agents) can be included in any layer of an imaging material, the accumulation of electrostatic charge can be prevented by reducing the surface resistivity or by lowering the charge level. This is usually done by including charge control agents in surface layers. Such surface layers may include what are known as “protective” overcoats or various backing layers in imaging materials. In thermographic materials, charge control agents may be incorporated into backside layers on the opposite side of the support as the imaging layers.

A wide variety of charge control agents, both inorganic and organic, have been devised and used for electrostatic charge control and numerous publications describe such agents. Some charge control agents are designed to increase surface layer conductivity while others are designed to control the generation of surface electrostatic charge.

U.S. Pat. No. 5,340,676 (Anderson et al.) describes the use of aqueous compositions containing various metal oxides in hydrophilic binders to provide conductive layers of various types of imaging elements. U.S. Published Application 2001-0055490 (Oyamada) describes the use of various metal oxides dispersed in one or more binders in conductive underlayers and in backcoat layers of thermally developable materials.

Fine particle metal antimonates are used in conductive layers of various imaging elements as described in U.S. Pat. No. 5,368,995 (Christian et al.) and U.S. Pat. No. 5,457,013 (Christian et al.). Various binders can be used in these conductive layers that can be located in various locations in the materials.

U.S. Pat. No. 5,731,119 (Eichorst et al.) describes the use of acicular metal oxides including zinc antimonate in conductive underlayers and in backcoat layers. Aqueous antistatic compositions containing granular zinc antimonate in a polyurethane latex binder are also described.

Polythiophene conductive layers are described as useful in thermo-graphic imaging materials in EP 440 957B1 (Jonas et al.) and EP 0 779 533 (Leenders et al.).

Despite the considerable research and knowledge in the art relating to the use of various conductive compositions and imaging materials, there remains a need for solvent-based conductive compositions that can be used on either side of the support in non-photosensitive thermographic materials to provide high conductivity and compatibility with underlying thermally sensitive imaging layers.

### SUMMARY OF THE INVENTION

The present invention provides a thermographic material consisting essentially of a polymer support and having on at least one or both sides thereof, one or more thermally sensitive imaging layers and an outermost non-thermally sensitive, conductive layer over the one or more thermally sensitive imaging layers,

the one or more thermally sensitive layers having in reactive association, a non-photosensitive source of reducible silver ions and a reducing agent composition for the reducible silver ions, and

the outermost non-thermally sensitive, conductive layer being an organic solvent-based conductive layer comprising non-acicular metal antimonate particles dispersed in a hydrophobic binder in an amount of at least 10 weight %.

Preferred embodiments of this invention comprise a black-and-white, non-photosensitive thermographic material that consists essentially of a transparent polymer support having on one or both sides thereof one or more thermally sensitive imaging layers and an outermost non-thermally sensitive conductive layer over the one or more thermally sensitive imaging layers,

the one or more thermally sensitive imaging layers comprising predominantly one or more hydrophobic binders including either polyvinyl butyral or a cellulose acetate polymer, and in reactive association, a non-photosensitive source of reducible silver ions that includes one or more silver aliphatic carboxylates at least one of which is highly crystalline silver behenate, a reducing agent composition for the non-photosensitive source reducible silver ions comprising an aromatic di- and tri-hydroxy compound having at least two hydroxy groups in ortho- or para-relationship on the same aromatic nucleus or mixture thereof, and

the conductive layer comprising either polyvinyl butyral or a cellulosic ester polymer and dispersed therein non-acicular metal antimonate particles composed of ZnSb₂O₆ and comprising from about 40 to about 55% of the dry weight of the conductive layer and are present in the conductive layer in an amount of from about 0.15 to about 23 g/m².

A method of this invention comprises imaging the thermographic material of the invention with a thermal imaging source to provide a visible image that can be used, for example, for medical diagnostic purposes.

This imaging method can be modified wherein the thermographic material comprises a transparent support and the image-forming method further comprises:

positioning the imaged thermographic material with the visible image thereon between a source of imaging radiation and an imageable material that is sensitive to the imaging radiation, and

thereafter exposing the imageable material to the imaging radiation through the visible image in the imaged thermographic material to provide an image in the imageable material.

The present invention provides a number of advantages with the use of specific metal antimonates in the outermost conductive layers of the non-photosensitive thermographic materials of this invention. These advantages include desired conductivity for the materials as well as added physical strength in the outermost layer. The metal particles are readily dispersed in organic solvents that also dissolve the common hydrophobic binders. In addition, the only essential layers needed for the performance of the thermographic materials of this invention consist of the one or more thermally sensitive imaging layers and the outermost conductive layer on either or both sides of the polymer support. Thus, unlike some imaging materials of the prior art, there are no magnetic layers present in the thermographic materials of this invention.

### DETAILED DESCRIPTION OF THE INVENTION

The thermographic materials of this invention can be used to provide black-and-white or color images using non-photosensitive silver salts, reducing compositions, binders, and other components known to be useful in such materials. The non-acicular metal antimonate particles described herein are generally incorporated into a separate outermost conductive (“antistatic”) layer on at least the backside and optionally on both sides of the support.

The thermographic materials of this invention can be used in black-and-white or color thermography and in electronically generated black-and-white or color hardcopy recording. They can be used as output media, in radiographic imaging (for example digital medical imaging), X-ray radiography, and in industrial radiography. Furthermore, the absorbance of these thermographic materials between 350 and 450 nm is desirably low (less than 0.5), to permit their use in the graphic arts area (for example, imagesetting and phototypesetting), in the manufacture of printing plates, in contact printing, in duplicating (“duping”), and in proofing.

The thermographic materials of this invention are particularly useful as output media for medical imaging of human or animal subjects in response to visible or X-radiation. Such applications include, but are not limited to, thoracic imaging, mammography, dental imaging, orthopedic imaging, general medical radiography, therapeutic radiography, veterinary radiography, and auto-radiography.

In the thermographic materials of this invention, the components needed for imaging can be in one or more thermally developable layers on one side (“frontside”) of the support. The layer(s) that contain the non-photosensitive source of reducible silver ions, or both, are referred to herein as thermographic emulsion layer(s) or thermally sensitive imaging layer(s).

Where the materials contain thermographic imaging layers on one side of the support only, various non-imaging layers can be disposed on the “backside” (non-emulsion or non-imaging side) of the materials, including the outermost conductive layer described herein. In addition, there are no magnetic layers on the back side of the support.

In such instances, various non-imaging layers can also be disposed on the “frontside,” imaging, or emulsion side of the support, including primer layers, interlayers, opacifying layers, subbing layers, carrier layers, antihalation layers, auxiliary layers, and other layers readily apparent to one skilled in the art. However, there are no magnetic layers on the imaging side of the support.

For some applications, the thermographic materials may be “double-sided” and have thermographic emulsion coating(s) or thermally sensitive imaging layer(s) on both sides of the support. In such constructions each side can also include one or more primer layers, interlayers, antistatic layers, auxiliary layers, anti-crossover layers, and other layers readily apparent to one skilled in the art. An outermost conductive layer can be on either or both sides of the support in these embodiments.

Definitions

As used herein:

In the descriptions of the thermographic materials of the present invention, “a” or “an” component refers to “at least one” of that component (for example, the specific metal antimonates in the conductive layer).

“Thermographic material(s)” means a construction comprising at least one thermographic emulsion layer or thermally sensitive imaging layer(s) wherein the source of reducible silver ions is in one layer and the other essential components or desirable additives are distributed, as desired, in the same layer or in an adjacent coating layer, as well as any supports, topcoat layers, image-receiving layers, carrier layers, blocking layers, antihalation layers, subbing or priming layers. These materials also include multilayer constructions in which one or more imaging components are in different layers, but are in “reactive association” so that they readily come into contact with each other during heat imaging and development. For example, one layer can include the non-photosensitive source of reducible silver ions and another layer can include the reducing composition, but the two reactive components are in reactive association with each other.

When used in thermography, the term, “imagewise exposing” or “imagewise exposure” means that the material is imaged using any means that provides an image using heat. This includes, for example, analog exposure where an image is formed by differential contact heating through a mask using a thermal blanket or infrared heat source, as well as by digital exposure where the image is formed one pixel at a time such as by modulation of thermal print-heads.

“Catalytic proximity” or “reactive association” means that the materials are in the same layer or in adjacent layers so that they readily come into contact with each other during thermal imaging and development.

“Emulsion layer,” “imaging layer,” or “thermographic emulsion layer,” means a layer of a thermographic material that contains the non-photo-sensitive source of reducible silver ions. It can also mean a layer of the thermographic material that contains, in addition to the non-photosensitive source of reducible ions, additional essential components and/or desirable additives. These layers are usually on what is known as the “frontside” of the support.

Many of the materials used herein are provided as a solution. The term “active ingredient” means the amount or the percentage of the desired material contained in a sample. All amounts listed herein are the amount of active ingredient added unless otherwise specified.

“Ultraviolet region of the spectrum” refers to that region of the spectrum less than or equal to 410 nm, and preferably from about 100 nm to about 410 nm, although parts of these ranges may be visible to the naked human eye. More preferably, the ultraviolet region of the spectrum is the region of from about 190 to about 405 nm.

“Visible region of the spectrum” refers to that region of the spectrum of from about 400 nm to about 700 nm.

“Short wavelength visible region of the spectrum” refers to that region of the spectrum of from about 400 nm to about 450 nm.

“Red region of the spectrum” refers to that region of the spectrum of from about 600 nm to about 700 nm.

“Infrared region of the spectrum” refers to that region of the spectrum of from about 700 nm to about 1400 nm.

“Non-photosensitive” means not intentionally light sensitive. The thermographic materials of the present invention are non-photosensitive and contain no purposely added photosensitive silver halide(s).

The sensitometric terms, absorbance, contrast, Dₘᵢₙ, and Dₘₐₓ have conventional definitions known in the imaging arts. In thermographic materials, Dₘᵢₙ is considered herein as image density in the non-thermally imaged areas of the thermographic material. The sensitometric term absorbance is another term for optical density (OD).

“Transparent” means capable of transmitting visible light or imaging radiation without appreciable scattering or absorption.

As used herein, the phrase “organic silver coordinating ligand” refers to an organic molecule capable of forming a bond with a silver atom. Although the compounds so formed are technically silver coordination compounds they are also often referred to as silver salts.

The terms “double-sided” and “double-faced coating” are used to define thermographic materials having one or more of the same or different thermographic emulsion layers disposed on both sides (front and back) of the support.

As is well understood in this art, for the chemical compounds herein described, substitution is not only tolerated, but is often advisable and various substituents are anticipated on the compounds used in the present invention unless otherwise stated. Thus, when a compound is referred to as “having the structure” of a given formula, any substitution that does not alter the bond structure of the formula or the shown atoms within that structure is included within the formula, unless such substitution is specifically excluded by language (such as “free of carboxy-substituted alkyl”). For example, where a benzene ring structure is shown (including fused ring structures), substituent groups may be placed on the benzene ring structure, but the atoms making up the benzene ring structure may not be replaced.

As a means of simplifying the discussion and recitation of certain substituent groups, the term “group” refers to chemical species that may be substituted as well as those that are not so substituted. Thus, the term “group,” such as “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. For example, alkyl group includes ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art. Substituents that adversely react with other active ingredients, such as very strongly electrophilic or oxidizing substituents, would, of course, be excluded by the ordinarily skilled artisan as not being inert or harmless.

Research Disclosure is a publication of Kenneth Mason Publications Ltd., Dudley House, 12 North Street, Emsworth, Hampshire PO10 7DQ England. It is also available from Emsworth Design Inc., 147 West 24th Street, New York, N.Y. 10011.

Other aspects, advantages, and benefits of the present invention are apparent from the detailed description, examples, and claims provided in this application.

Non-Photosensitive Source of Reducible Silver Ions

The non-photosensitive source of reducible silver ions used in the thermographic materials of this invention can be any metal-organic compound that contains reducible silver (1+) ions. Such compounds are generally silver salts of silver coordinating ligands. Preferably, it is an organic silver salt that is comparatively stable to light and forms a silver image when heated to 50° C. or higher in the presence of a reducing agent composition.

Silver salts of organic acids including silver salts of long-chain carboxylic acids are preferred. The chains typically contain 10 to 30, and preferably 15 to 28, carbon atoms. Suitable organic silver salts include silver salts of organic compounds having a carboxylic acid group. Examples thereof include a silver salt of an aliphatic carboxylic acid or a silver salt of an aromatic carboxylic acid. Preferred examples of the silver salts of aliphatic carboxylic acids include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Preferably, at least silver behenate is used alone or in mixtures with other silver salts.

Representative examples of useful silver salts of aromatic carboxylic acid and other carboxylic acid group-containing compounds include, but are not limited to, silver benzoate, silver substituted-benzoates (such as silver 3,5-dihydroxy-benzoate, silver o-methylbenzoate, silver m-methylbenzoate, silver p-methylbenzoate, silver 2,4-dichlorobenzoate, silver acetamidobenzoate, silver p-phenylbenzoate), silver tannate, silver phthalate, silver terephthalate, silver salicylate, silver phenylacetate, and silver pyromellitate.

Silver salts of aliphatic carboxylic acids containing a thioether group as described in U.S. Pat. No. 3,330,663 (Weyde et al.) are also useful. Soluble silver carboxylates comprising hydrocarbon chains incorporating ether or thioether linkages, or sterically hindered substitution in the α- (on a hydrocarbon group) or ortho- (on an aromatic group) position. Such silver carboxylates are described in U.S. Pat. No. 5,491,059 (Whitcomb). Mixtures of any of the silver salts described herein can also be used if desired.

Silver salts of dicarboxylic acids are also useful. Such acids may be aliphatic, aromatic, or heterocyclic. Examples of such acids include, for example, phthalic acid, glutamic acid, or homo-phthalic acid.

Silver salts of sulfonates are also useful in the practice of this invention. Such materials are described for example in U.S. Pat. No. 4,504,575 (Lee). Silver salts of sulfosuccinates are also useful as described for example in EP 0 227 141 A1 (Leenders et al.).

Moreover, silver salts of acetylenes can also be used as described, for example in U.S. Pat. No. 4,761,361 (Ozaki et al.) and U.S. Pat. No. 4,775,613 (Hirai et al.).

Silver salts of compounds containing mercapto or thione groups and derivatives thereof can also be used. Preferred examples of these compounds include, but are not limited to, a heterocyclic nucleus containing 5 or 6 atoms in the ring, at least one of which is a nitrogen atom, and other atoms being carbon, oxygen, or sulfur atoms. Such heterocyclic nuclei include, but are not limited to, triazoles, oxazoles, thiazoles, thiazolines, imidazoles, diazoles, pyridines, and triazines. Representative examples of these silver salts include, but are not limited to, a silver salt of 3-mercapto-4-phenyl-1,2,4-triazole, a silver salt of 5-carboxylic-1-methyl-2-phenyl-4-thiopyridine, a silver salt of mercaptotriazine, a silver salt of 2-mercaptobenzoxazole, silver salts as described in U.S. Pat. No. 4,123,274 (Knight et al.) (for example, a silver salt of a 1,2,4-mercaptothiazole derivative, such as a silver salt of 3-amino-5-benzylthio-1,2,4-thiazole), and a silver salt of thione compounds [such as a silver salt of 3-(2-carboxyethyl)-4-methyl-4-thiazoline-2-thione as described in U.S. Pat. No. 3,785,830 (Sullivan et al.)].

Examples of other useful silver salts of mercapto or thione substituted compounds that do not contain a heterocyclic nucleus include but are not limited to, a silver salt of thioglycolic acids such as a silver salt of an S-alkyl-thioglycolic acid (wherein the alkyl group has from 12 to 22 carbon atoms), a silver salt of a dithiocarboxylic acid such as a silver salt of a dithioacetic acid, and a silver salt of a thioamide.

A silver salt of a compound containing an imino group can also be used. Examples of these compounds include, but are not limited to, silver salts of benzotriazole and substituted derivatives thereof (for example, silver methyl-benzotriazole and silver 5-chlorobenzotriazole), silver salts of 1,2,4-triazoles or 1 -H-tetrazoles such as phenylmercaptotetrazole as described in U.S. Pat. No. 4,220,709 (deMauriac), and silver salts of imidazoles and imidazole derivatives as described in U.S. Pat. No. 4,260,677 (Winslow et al.). Particularly useful silver salts of this type are the silver salts of benzotriazole and substituted derivatives thereof.

Organic silver salts that are particularly useful in organic solvent-based thermographic materials include silver carboxylates (both aliphatic and aromatic carboxylates), silver triazolates, silver sulfonates, silver sulfosuccinates, and silver acetylides. Silver salts of long-chain aliphatic carboxylic acids containing 15 to 28, carbon atoms and silver salts are particularly preferred.

It is also convenient to use silver half soaps. A preferred example of a silver half soap is an equimolar blend of silver carboxylate and carboxylic acid, which analyzes for about 14.5% by weight solids of silver in the blend and which is prepared by precipitation from an aqueous solution of an ammonium or an alkali metal salt of a commercially available fatty carboxylic acid, or by addition of the free fatty acid to the silver soap. For transparent films a silver carboxylate full soap, containing not more than about 15% of free fatty carboxylic acid and analyzing for about 22% silver, can be used.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.) and the references cited above.

Non-photosensitive sources of reducible silver ions can also be provided as core-shell silver salts such as those described in U.S. Pat. No. 6,355,408 (Whitcomb et al.), that is incorporated herein by reference. These silver salts include a core comprised of one or more silver salts and a shell having one or more different silver salts.

Another useful source of non-photosensitive reducible silver ions in the practice of this invention are the silver dimer compounds that comprise two different silver salts as described in U.S. Pat. No. 6,472,131 (Whitcomb), that is incorporated herein by reference. Such non-photosensitive silver dimer compounds comprise two different silver salts, provided that when the two different silver salts comprise straight-chain, saturated hydrocarbon groups as the silver coordinating ligands, those ligands differ by at least 6 carbon atoms.

Still other useful sources of non-photosensitive reducible silver ions in the practice of this invention are the silver core-shell compounds comprising a primary core comprising one or more photosensitive silver halides, or one or more non-photosensitive inorganic metal salts or non-silver containing organic salts, and a shell at least partially covering the primary core, wherein the shell comprises one or more non-photosensitive silver salts, each of which silver salts comprises a organic silver coordinating ligand. Such compounds are described in copending and commonly assigned U.S. Ser. No. 10/208,603 (filed Jul. 30, 2002 by Bokhonov, Burleva, Whitcomb, Howlader, and Leichter), that is incorporated herein by reference.

As one skilled in the art would understand, the non-photosensitive source of reducible silver ions can include various mixtures of the various silver salt compounds described herein, in any desirable proportions.

In some embodiments, a highly crystalline silver behenate can be used as part or all of the non-photosensitive sources of reducible silver ions. Such silver behenate and methods for its preparation are described for example in U.S. Pat. No. 6,096,486 (Emmers et al.) and U.S. Pat. No. 6,159,667 (Emmers et al.), both incorporated herein by reference. Moreover, the silver behenate can be used in its one or more crystallographic phases (such as a mixture of phases I, II and/or III) as described for example in EP 1 158 355 (Geuens et al.), incorporated herein by reference.

The one or more non-photosensitive sources of reducible silver ions are preferably present in an amount of about 5% by weight to about 70% by weight, and more preferably, about 10% to about 50% by weight, based on the total dry weight of the emulsion layers. Stated another way, the amount of the sources of reducible silver ions is generally present in an amount of from about 0.001 to about 0.2 mol/m² of the thermographic material, and preferably from about 0.01 to about 0.05 mol/m² of that material.

The total amount of silver in the thermographic materials is generally at least 0.002 mol/m² and preferably from about 0.01 to about 0.05 mol/m².

Reducing Agents

When used in a thermographic material, the reducing agent (or reducing agent composition comprising two or more components) for the source of reducible silver ions can be any material, preferably an organic material, that can reduce silver (1+) ion to metallic silver. For example, useful reducing agents are organic compounds containing at least one active hydrogen atom linked to an oxygen, nitrogen, or carbon atom.

Conventional photographic developers can be used as reducing agents, including aromatic di- and tri-hydroxy compounds (such as hydroquinones, gallatic acid and gallic acid derivatives, catechols, and pyrogallols), aminophenols (for example, N-methylaminophenol), p-phenylene-diamines, alkoxynaphthols (for example, 4-methoxy-1-naphthol), pyrazolidin-3-one type reducing agents (for example PHENIDONE®), pyrazolin-5-ones, polyhydroxy spiro-bis-indanes, indan-1,3-dione derivatives, hydroxytetrone acids, hydroxytetronimides, hydroxylamine derivatives such as for example those described in U.S. Pat. No. 4,082,901 (Laridon et al.), hydrazine derivatives, hindered phenols, amidoximes, azines, reductones (for example, ascorbic acid and ascorbic acid derivatives), leuco dyes, and other materials readily apparent to one skilled in the art.

When used with a silver carboxylate silver source in a thermo-graphic material, preferred reducing agents are aromatic di- and tri-hydroxy compounds having at least two hydroxy groups in ortho- or para-relationship on the same aromatic nucleus. Examples are hydroquinone and substituted hydroquinones, catechols, pyrogallol, gallic acid and gallic acid esters (for example, methyl gallate, ethyl gallate, propyl gallate), and tannic acid.

Particularly preferred are reducing catechol-type reducing agents having no more than two hydroxy groups in an ortho-relationship. Preferred catechol-type reducing agents include, for example, catechol, 3-(3,4-dihydroxy-phenyl)-propionic acid, 2,3-dihydroxy-benzoic acid, 2,3-dihydroxy-benzoic acid esters, 3,4-dihydroxy-benzoic acid, and 3,4-dihydroxy-benzoic acid esters.

One particularly preferred class of catechol-type reducing agents are benzene compounds in which the benzene nucleus is substituted by no more than two hydroxy groups which are present in 2,3-position on the nucleus and have in the 1-position of the nucleus a substituent linked to the nucleus by means of a carbonyl group. Compounds of this type include 2,3-dihydroxy-benzoic acid, methyl 2,3-dihydroxy-benzoate, and ethyl 2,3-dihydroxy-benzoate.

Another particularly preferred class of catechol-type reducing agents are benzene compounds in which the benzene nucleus is substituted by no more than two hydroxy groups which are present in 3,4-position on the nucleus and have in the 1-position of the nucleus a substituent linked to the nucleus by means of a carbonyl group. Compounds of this type include, for example, 3,4-dihydroxy-benzoic acid, methyl 3,4-dihydroxy-benzoate, ethyl 3,4-dihydroxy-benzoate, butyl 3,4-dihydroxybenzoate, 3,4-dihydroxy-benzaldehyde, and phenyl-(3,4-dihydroxyphenyl)ketone. Such compounds are described, for example, in U.S. Pat. No. 5,582,953 (Uyttendaele et al.), that is incorporated herein by reference.

Mixtures of catechol-type reducing agents can be used if desired.

Still another particularly useful class of reducing agents are polyhydroxy spiro-bis-indane compounds described as photographic tanning agents in U.S. Pat. No. 3,440,049 (Moede) and as reducing agents in U.S. Pat. No. 5,817,598 (Defieuw et al.), both incorporated herein by reference. Examples include 3,3,3′,3′-tetramethyl-5,6,5′,6′-tetrahydroxy-1,1′-spiro-bis-indane (called indane I) and 3,3,3′,3′-tetramethyl-4,6,7,4′,6′,7′-hexahydroxy-1,1′-spiro-bis-indane (called indane II).

When used with a silver salt containing an imino group, preferred reducing agents are ascorbic acid reducing agents. An “ascorbic acid” reducing agent (also referred to as a developer or developing agent) means ascorbic acid, complexes, and derivatives thereof Ascorbic acid developing agents are described in a considerable number of publications in photographic processes, including U.S. Pat. No. 5,236,816 (Purol et al.) and references cited therein. Useful ascorbic acid developing agents include ascorbic acid and the analogues, isomers and derivatives thereof. Such compounds include, but are not limited to, D- or L-ascorbic acid, sugar-type derivatives thereof (such as sorboascorbic acid, γ-lactoascorbic acid, 6-desoxy-L-ascorbic acid, L-rhamnoascorbic acid, imino-6-desoxy-L-ascorbic acid, glucoascorbic acid, fucoascorbic acid, glucoheptoascorbic acid, maltoascorbic acid, L-arabosascorbic acid), sodium ascorbate, potassium ascorbate, isoascorbic acid (or L-erythroascorbic acid), and salts thereof (such as alkali metal, ammonium or others known in the art), endiol type ascorbic acid, an enaminol type ascorbic acid, a thioenol type ascorbic acid, and an enamin-thiol type ascorbic acid, as described for example in U.S. Pat. No. 5,498,511 (Yamashita et al.), EP 0 585 792 A1 (Passarella et al.), EP 0 573 700 A1 (Lingier et al.), EP 0 588 408A1 (Hieronymus et al.), U.S. Pat. No. 5,089,819 (Knapp), U.S. Pat. No. 5,278,035 (Knapp), U.S. Pat. No. 5,384,232 (Bishop et al.), U.S. Pat. No. 5,376,510 (Parker et al.), Japanese Kokai 7-56286 (Toyoda), U.S. Pat. No. 2,688,549 (James et al.), and Research Disclosure, item 37152, March 1995. D-, L-, or D,L-ascorbic acid (and alkali metal salts thereof) or isoascorbic acid (or alkali metal salts thereof) are preferred. Mixtures of these developing agents can be used if desired.

In some constructions, “hindered phenol reducing agents” can be used. Hindered phenol reducing agents” are compounds that contain only one hydroxy group on a given phenyl ring and have at least one additional substituent located ortho to the hydroxy group. Hindered phenol reducing agents may contain more than one hydroxy group as long as each hydroxy group is located on different phenyl rings. Hindered phenol reducing agents include, for example, binaphthols (that is dihydroxybinaphthyls), biphenols (that is dihydroxybiphenyls), bis(hydroxynaphthyl)methanes, bis(hydroxyphenyl)methanes (that is bisphenols), hindered phenols, and hindered naphthols, each of which may be variously substituted.

Representative binaphthols include, but are not limited, to 1,1′-bi-2-naphthol, 1,1′-bi-4-methyl-2-naphthol and 6,6′-dibromo-bi-2-naphthol. For additional compounds see U.S. Pat. No. 3,094,417 (Workman) and U.S. Pat. No. 5,262,295 (Tanaka et al.), both incorporated herein by reference.

Representative biphenols include, but are not limited, to 2,2′-dihydroxy-3,3′-di-t-butyl-5,5-dimethylbiphenyl, 2,2′-dihydroxy-3,3′,5,5 ′-tetra-t-butylbiphenyl, 2,2′-dihydroxy-3,3′-di-t-butyl-5,5′-dichloro-biphenyl, 2-(2-hydroxy-3-t-butyl-5-methylphenyl)-4-methyl-6-n-hexylphenol, 4,4′-dihydroxy-3,3′,5,5′-tetra-t-butylbiphenyl and 4,4′-dihydroxy-3,3′,5,5′-tetra-methylbiphenyl. For additional compounds see U.S. Pat. No. 5,262,295 (noted above).

Representative bis(hydroxynaphthyl)methanes include, but are not limited to, 4,4′-methylenebis(2-methyl-1-naphthol). For additional compounds see U.S. Pat. No. 5,262,295 (noted above).

Representative bis(hydroxyphenyl)methanes include, but are not limited to, bis(2-hydroxy-3-t-butyl-5-methylphenyl)methane (CAO-5), 1,1′-bis(2-hydroxy-3,5-dimethylphenyl)-3,5,5-trimethylhexane (NONOX® or PERMANAX WSO), 1,1′-bis(3,5-di-t-butyl-4-hydroxyphenyl)methane, 2,2′-bis(4-hydroxy-3-methylphenyl)propane, 4,4′-ethylidene-bis(2-t-butyl-6-methylphenol), 2,2′-isobutylidene-bis(4,6-dimethylphenol) (LOWINOX® 221B46), and 2,2′-bis(3,5-dimethyl-4-hydroxyphenyl)propane. For additional compounds see U.S. Pat. No. 5,262,295 (noted above).

Representative hindered phenols include, but are not limited to, 2,6-di-t-butylphenol, 2,6-di-t-butyl-4-methylphenol, 2,4-di-t-butylphenol, 2,6-dichlorophenol, 2,6-dimethylphenol and 2-t-butyl-6-methylphenol.

Representative hindered naphthols include, but are not limited to, 1-naphthol, 4-methyl-1-naphthol, 4-methoxy-1-naphthol, 4-chloro-1-naphthol and 2-methyl-1-naphthol. For additional compounds see U.S. Pat. No. 5,262,295 (noted above).

Mixtures of hindered phenol reducing agents can be used if desired.

In some instances, the reducing agent composition comprises two or more components such as a hindered phenol developer and a co-developer that can be chosen from the various classes of co-developers and reducing agents described below. Ternary developer mixtures involving the further addition of contrast enhancing agents are also useful. Such contrast enhancing agents can be chosen from the various classes of reducing agents described below.

Useful co-developer reducing agents can also be used as described for example, in U.S. Pat. No. 6,387,605 (Lynch et al.), that is incorporated herein by reference. Examples of these compounds include, but are not limited to, 2,5-dioxo-cyclopentane carboxaldehydes, 5-(hydroxymethylene)-2,2-dimethyl-1,3-dioxane-4,6-diones, 5-(hydroxymethylene)-1,3-dialkylbarbituric acids, and 2-(ethoxymethylene)-1H-indene-1,3(2H)-diones.

Additional classes of reducing agents that can be used as co-developers are trityl hydrazides and formyl phenyl hydrazides as described in U.S. Pat. No. 5,496,695 (Simpson et al.), 2-substituted malondialdehyde compounds as described in U.S. Pat. No. 5,654,130 (Murray), and 4-substituted isoxazole compounds as described in U.S. Pat. No. 5,705,324 (Murray). Additional developers are described in U.S. Pat. No. 6,100,022 (Inoue et al.). All of the patents above are incorporated herein by reference.

Yet another class of co-developers includes substituted acrylonitrile compounds that are described in U.S. Pat. No. 5,635,339 (Murray) and U.S. Pat. No. 5,545,515 (Murray et al.), both incorporated herein by reference. Examples of such compounds include, but are not limited to, the compounds identified as HET-01 and HET-02 in U.S. Pat. No. 5,635,339 (noted above) and CN-01 through CN-13 in U.S. Pat. No. 5,545,515 (noted above). Particularly useful compounds of this type are (hydroxymethylene)cyanoacetates and their metal salts.

Additional reducing agents that have been disclosed in dry silver systems including amidoximes such as phenylamidoxime, 2-thienylamidoxime and p-phenoxyphenylamidoxime, azines (for example, 4-hydroxy-3,5-dimethoxy-benzaldehydrazine), a combination of aliphatic carboxylic acid aryl hydrazides and ascorbic acid [such as 2,2′-bis(hydroxymethyl)-propionyl-β-phenyl hydrazide in combination with ascorbic acid], a combination of polyhydroxybenzene and hydroxylamine, a reductone and/or a hydrazine [for example, a combination of hydroquinone and bis(ethoxyethyl)hydroxylamine], piperidinohexose reductone or formyl-4-methylphenylhydrazine, hydroxamic acids (such as phenylhydroxamic acid, p-hydroxyphenylhydroxamic acid, and o-alaninehydroxamic acid), a combination of azines and sulfonamidophenols (for example, phenothiazine and 2,6-dichloro-4-benzenesulfonamidophenol), α-cyanophenylacetic acid derivatives (such as ethyl α-cyano-2-methylphenylacetate and ethyl α-cyanophenylacetate), bis-o-naphthols [such as 2,2′-dihydroxyl-1-binaphthyl, 6,6′-dibromo-2,2′-dihydroxy-1,1′-binaphthyl, and bis(2-hydroxy-1-naphthyl)methane], a combination of bis-o-naphthol and a 1,3-dihydroxybenzene derivative (for example, 2,4-dihydroxybenzophenone or 2,4-dihydroxyacetophenone), 5-pyrazolones such as 3-methyl-1-phenyl-5-pyrazolone, reductones (such as dimethylaminohexose reductone, anhydrodihydro-aminohexose reductone and anhydrodihydro-piperidone-hexose reductone), sulfonamidophenol reducing agents (such as 2,6-dichloro-4-benzenesulfonamido-phenol, and p-benzenesulfon-amidophenol), indane-1,3-diones (such as 2-phenylindane-1,3-dione), chromans (such as 2,2-dimethyl-7-t-butyl-6-hydroxychroman), 1,4-dihydropyridines (such as 2,6-dimethoxy-3,5-dicarbethoxy-1,4-dihydropyridine), ascorbic acid derivatives (such as 1-ascorbylpalmitate, ascorbylstearate and unsaturated aldehydes and ketones), and 3-pyrazolidones.

A further class of reducing agents that can be used as developers are substituted hydrazines including the sulfonyl hydrazides described in U.S. Pat. No. 5,464,738 (Lynch et al.). Still other useful reducing agents are described, for example, in U.S. Pat. No. 3,074,809 (Owen), U.S. Pat. No. 3,094,417 (Workman), U.S. Pat. No. 3,080,254 (Grant, Jr.), and U.S. Pat. No. 3,887,417 (Klein et al.). Auxiliary reducing agents may be useful as described in U.S. Pat. No. 5,981,151 (Leenders et al.). All of these patents are incorporated herein by reference.

The reducing agent (or mixture thereof) described herein is generally present as 1 to 10% (dry weight) of the thermographic emulsion layer. In multilayer constructions, if the reducing agent is added to a layer other than an emulsion layer, slightly higher proportions, of from about 2 to 15 weight % may be more desirable. Any co-developers may be present generally in an amount of from about 0.001% to about 1.5% (dry weight) of the thermographic emulsion layer coating.

For color imaging materials (for example, monochrome, dichrome, or full color images), one or more reducing agents can be used that can be oxidized directly or indirectly to form or release one or more dyes.

The dye-forming or releasing compound may be any colored, colorless, or lightly colored compound that can be oxidized to a colored form, or to release a preformed dye when heated, preferably to a temperature of from about 80° C. to about 250° C. for a duration of at least 1 second. When used with a dye- or image-receiving layer, the dye can diffuse through the imaging layers and interlayers into the image-receiving layer of the thermographic material.

Leuco dyes or “blocked” leuco dyes are one class of dye-forming compounds (or “blocked” dye-forming compounds) that form and release a dye upon oxidation by silver ion to form a visible color image in the practice of the present invention. Leuco dyes are the reduced form of dyes that are generally colorless or very lightly colored in the visible region (optical density of less than 0.2). Thus, oxidation provides a color change that is from colorless to colored, an optical density increase of at least 0.2 units, or a substantial change in hue.

Representative classes of useful leuco dyes include, but are not limited to, chromogenic leuco dyes (such as indoaniline, indophenol, or azomethine dyes), imidazole leuco dyes such as 2-(3,5-di-t-butyl-4-hydroxy-phenyl)-4,5-diphenylimidazole as described for example in U.S. Pat. No. 3,985,565 (Gabrielson et al.), dyes having an azine, diazine, oxazine, or thiazine nucleus such as those described for example in U.S. Pat. No. 4,563,415 (Brown et al.), U.S. Pat. No. 4,622,395 (Bellus et al.), U.S. Pat. No. 4,710,570 (Thien), and U.S. Pat. No. 4,782,010 (Mader et al.), and benzlidene leuco compounds as described for example in U.S. Pat. No. 4,932,792 (Grieve et al.), all incorporated herein by reference. Further details about the chromogenic leuco dyes noted above can be obtained from U.S. Pat. No. 5,491,059 (noted above, Column 13) and references noted therein.

Another useful class of leuco dyes includes what are known as “aldazine” and “ketazine” leuco dyes that are described for example in U.S. Pat. No. 4,587,211 (Ishida et al.) and U.S. Pat. No. 4,795,697 (Vogel et al.), both incorporated herein by reference.

Still another useful class of dye-releasing compounds includes those that release diffuisible dyes upon oxidation. These are known as preformed dye release (PDR) or redox dye release (RDR) compounds. In such compounds, the reducing agents release a mobile preformed dye upon oxidation. Examples of such compounds are described in U.S. Pat. No. 4,981,775 (Swain), incorporated herein by reference.

The dyes that are formed or released can be the same in the same or different imaging layers. A difference of at least 60 nm in reflective maximum absorbance is preferred. More preferably, this difference is from about 80 to about 100 nm. Further details about the various dye absorbance are provided in U.S. Pat. No. 5,491,059 (noted above, Col. 14).

The total amount of one or more dye-forming or releasing compound that can be incorporated into the thermographic materials of this invention is generally from about 0.5 to about 25 weight % of the total weight of each imaging layer in which they are located. Preferably, the amount in each imaging layer is from about 1 to about 10 weight %, based on the total dry layer weight. The useful relative proportions of the leuco dyes would be readily known to a skilled worker in the art.

Other Addenda

The thermographic materials of this invention can also contain other additives such as toners, shelf-life stabilizers, contrast enhancers, dyes or pigments, post-processing stabilizers or stabilizer precursors, thermal solvents (also known as melt formers), and other image-modifying agents as would be readily apparent to one skilled in the art.

Other suitable stabilizers that can be used alone or in combination include thiazolium salts as described in U.S. Pat. No. 2,131,038 (Staud) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), compounds having —SO₂CBr₃ groups as described for example in U.S. Pat. No. 5,594,143 (Kirk et al.) and U.S. Pat. No. 5,374,514 (Kirk et al.), and 2-(tribromomethylsulfonyl)quinoline compounds as described in U.S. Pat. No. 5,460,938 (Kirk et al.).

Stabilizer precursor compounds capable of releasing stabilizers upon application of heat during imaging can also be used. Such precursor compounds are described in for example, U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

In addition, certain substituted-sulfonyl derivatives of benzo-triazoles (for example alkylsulfonylbenzotriazoles and arylsulfonylbenzotriazoles) have been found to be useful stabilizing compounds (such as for post-processing print stabilizing), as described in U.S. Pat. No. 6,171,767 (Kong et al.).

Furthermore, other specific stabilizers are described in more detail in U.S. Pat. No. 6,083,681 (Lynch et al.), incorporated herein by reference.

Advantageously, the thermographic materials of this invention also include one or more thermal solvents (or melt formers). Representative examples of such compounds include, but are not limited to, salicylanilide, phthalimide, N-hydroxyphthalimide, N-potassium-phthalimide, succinimide, N-hydroxy-1,8-naphthalimide, phthalazine, 1-(2H)-phthalazinone, 2-acetylphthalazinone, benzanilide, dimethylurea, D-sorbitol, and benzenesulfonamide. Combinations of these compounds can also be used including a combination of succinimide and dimethylurea. Known thermal solvents are disclosed, for example, in U.S. Pat. No. 3,438,776 (Yudelson), U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender).

The use of “toners” or derivatives thereof that improve the image are highly desirable components of the thermographic materials of this invention. Toners are compounds that when added to the imaging layer, shift the color of the image from yellowish-orange to brown-black or blue-black. Generally, one or more toners described herein are present in an amount of about 0.01% by weight to about 10%, and more preferably about 0.1% by weight to about 10% by weight, based on the total dry weight of the layer in which it is included. Toners may be incorporated in the thermographic emulsion layer or in an adjacent layer.

Such compounds are well known materials in the art, as shown in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), U.S. Pat. No. 5,599,647 (Defieuw et al.) and GB 1,439,478 (AGFA).

Examples of toners include, but are not limited to, phthalimide and N-hydroxyphthalimide, cyclic imides (such as succinimide), pyrazoline-5-ones, quinazolinone, 1-phenylurazole, 3-phenyl-2-pyrazoline-5-one, and 2,4-thiazolidinedione, naphthalimides (such as N-hydroxy-1,8-naphthalimide), cobalt complexes [such as hexaaminecobalt(3+) trifluoroacetate], mercaptans (such as 3-mercapto-1,2,4-triazole, 2,4-dimercaptopyrimidine, 3-mercapto-4,5-diphenyl-1,2,4-triazole and 2,5-dimercapto-1,3,4-thiadiazole), N-(amino-methyl)aryldicarboximides (such as (N,N-dimethylaminomethyl)phthalimide), and N-(dimethylaminomethyl)naphthalene-2,3-dicarboximide, a combination of blocked pyrazoles, isothiuronium derivatives, and certain photobleach agents [such as a combination of N,N′-hexamethylene-bis(1-carbamoyl-3,5-dimethyl-pyrazole), 1,8-(3,6-diazaoctane)bis(isothiuronium)trifluoroacetate, and 2-(tribromomethylsulfonyl benzothiazole)], merocyanine dyes {such as 3-ethyl-5-[(3-ethyl-2-benzothiazolinylidene)-1-methyl-ethylidene]-2-thio-2,4-o-azolidine-dione}, phthalazine and derivatives thereof [such as those described in U.S. Pat. No. 6,146,822 (Asanuma et al.)], phthalazinone and phthalazinone derivatives, or metal salts or these derivatives [such as 4-(1-naphthyl)phthalazinone, 6-chlorophthalazinone, 5,7-dimethoxyphthalazinone, and 2,3-dihydro-1,4-phthalazinedione], a combination of phthalazine (or derivative thereof) plus one or more phthalic acid derivatives (such as phthalic acid, 4-methylphthalic acid, 4-nitrophthalic acid, and tetrachlorophthalic anhydride), quinazolinediones, benzoxazine or naphthoxazine derivatives, rhodium complexes functioning not only as tone modifiers but also as sources of halide ion for silver halide formation in-situ [such as ammonium hexachlororhodate (3+), rhodium bromide, rhodium nitrate, and potassium hexachlororhodate (3+)], benzoxazine-2,4-diones and naphthoxazine diones (such as 1,3-benzoxazine-2,4-dione, 8-methyl-1,3-benzoxazine-2,4-dione, 3,4-dihydro-2,4-dioxo-1,3,2H-benzoxazine, 3,4-dihydro-2,4-dioxo-1,3,7-ethylcarbonatobenzoxazine, and 6-nitro-1,3-benz-oxazine-2,4-dione) as described in U.S. Pat. No. 5,817,598 (noted above), pyrimidines and asym-triazines (such as 2,4-dihydroxypyrimidine, 2-hydroxy-4-aminopyrimidine and azauracil) and tetraazapentalene derivatives [such as 3,6-dimercapto-1,4-diphenyl-]H,4H-2,3a,5,6a-tetraazapentalene and 1,4-di-(o-chlorophenyl)-3,6-dimercapto-1H,4H-2,3a,5,6a-tetraazapentalene].

Also useful are the phthalazine compounds described in copending and commonly assigned U.S. Ser. No. 10/281,525 (filed Oct. 28, 2002 by Ramsden and Zou), the triazine thione compounds described in copending and commonly assigned U.S. Ser. No. 10/341,754 (filed Jan. 14, 2003 by Lynch, Ulrich, and Skoug), as well as the heterocyclic disulfide compounds described in in copending and commonly assigned U.S. Ser. No. 10/384,244 (filed Mar. 7, 2003 by Lynch and Ulrich), all of which are incorporated herein by reference.

The thermographic materials of this invention can also include one or more image stabilizing compounds that are usually incorporated in a “backside” layer. Such compounds can include, but are not limited to, phthalazinone and its derivatives, pyridazine and its derivatives, benzoxazine and benzoxazine derivatives, benzothiazine dione and its derivatives, and quinazoline dione and its derivatives, particularly as described in copending and commonly assigned U.S. Ser. No. 10/041,386 (filed Jan. 8, 2002 by Kong). Other useful backside image stabilizers include, but are not limited to, anthracene compounds, coumarin compounds, benzophenone compounds, benzotriazole compounds, naphthalic acid imide compounds, pyrazoline compounds, or compounds described for example, in U.S. Pat. No. 6,465,162 (Kong et al.) and GB 1,565,043 (Fuji Photo). All of these patents and patent applications are incorporated herein by reference.

The thermographic materials may also include one or more polycarboxylic acids and/or anhydrides thereof that are in thermal working relationship with the sources of reducible silver ions. Such polycarboxylic acids can be substituted or unsubstituted aliphatic or aromatic compounds. They can be used in anhydride or partially esterified form as long as two free carboxylic acids remain in the molecule. Useful polycarboxylic acids are described for example in U.S. Pat. No. 6,096,486 (noted above).

Binders

The non-photosensitive source of reducible silver ions, the reducing agent composition described above, and any other imaging layer additives used in the present invention are generally added to one or more binders that are predominantly (at least 50% by weight of total binders) hydrophobic in nature. Thus, organic solvent-based formulations are used to prepare the thermographic materials of this invention. Mixtures of hydrophobic binders can also be used. It is preferred that at least 80% (by weight) of the binders be hydrophobic polymeric materials such as, for example, natural and synthetic resins that are sufficiently polar to hold the other ingredients in solution or suspension.

Examples of typical hydrophobic binders include, but are not limited to, polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral and polyvinyl formal), cellulose ester polymers, and vinyl copolymers (such as polyvinyl acetate and polyvinyl chloride) are preferred. Particularly suitable binders are polyvinyl butyral resins that are available as BUTVAR® B79 (Solutia, Inc.) and PIOLOFORM® BS-18 or PIOLOFORM® BL-16 (Wacker Chemical Company) and cellulose ester polymers.

Examples of useful hydrophilic binders that can be used in minor amounts include, but are not limited to, proteins and protein derivatives, gelatin and gelatin-like derivatives (hardened or unhardened, including alkali- and acid-treated gelatins, acetylated gelatin, oxidized gelatin, phthalated gelatin, and deionized gelatin), cellulosic materials such as hydroxymethyl cellulose and cellulosic esters, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides (such as dextrans and starch ethers), and other synthetic or naturally occurring vehicles commonly known for use in aqueous-based photographic emulsions. Cationic starches can be used as a peptizer for tabular silver halide grains as described in U.S. Pat. No. 5,620,840 (Maskasky) and U.S. Pat. No. 5,667,955 (Maskasky).

Water-dispersible binders including water-dispersible latex polymers can also be used in minor amounts in the thermographic materials of this invention. Such materials are well known in the art including U.S. Pat. No. 6,096,486 (noted above).

Hardeners for various binders may be present if desired. Useful hardeners are well known and include diisocyanate compounds as described for example, in EP 0 600 586 B1 (Philip, Jr. et al.) and vinyl sulfone compounds as described in U.S. Pat. No. 6,143,487 (Philip, Jr. et al.), and EP 0 640 589A1 (Gathmann et al.), aldehydes and various other hardeners as described in U.S. Pat. No. 6,190,822 (Dickerson et al.). The hydrophilic binders used in the thermo-graphic materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-8.

Where the proportions and activities of the thermographic materials require a particular imaging time and temperature, the binder(s) should be able to withstand those conditions. When a hydrophobic binder is used, it is preferred that the binder does not decompose or lose its structural integrity at 120° C. for 60 seconds. When a hydrophilic binder is used, it is preferred that the binder does not decompose or lose its structural integrity at 150° C. for 60 seconds. It is more preferred that it does not decompose or lose its structural integrity at 177° C. for 60 seconds.

The polymer binder(s) is used in an amount sufficient to carry the components dispersed therein. The effective range of amount of polymer can be appropriately determined by one skilled in the art. Preferably, a binder is used at a level of about 10% by weight to about 90% by weight, and more preferably at a level of about 20% by weight to about 70% by weight, based on the total dry weight of the layer in which it is included.

It is particularly useful in the thermographic materials of this invention to use predominantly (more than 50% by weight of total binder weight) hydrophobic binders in both imaging and non-imaging layers on both sides of the support. In particular, the outermost conductive layers described in more detail below are generally formulated and disposed on the support with one or more hydrophobic binders such as cellulose ester polymer binders. Of these binders, cellulose nitrate, cellulose acetate, cellulose acetate butyrate, and cellulose acetate propionate are preferred. Cellulose acetate butyrate is more preferred. In most preferred embodiments, cellulose acetate butyrate is the only binder in the conductive antistatic layers.

Support Materials

The thermographic materials of this invention comprise a polymeric support that is preferably a flexible, transparent film that has any desired thickness and is composed of one or more polymeric materials, depending upon their use. The supports are generally transparent (especially if the material is used as a photomask) or at least translucent, but in some instances, opaque supports may be useful. They are required to exhibit dimensional stability during thermal imaging and development and to have suitable adhesive properties with overlying layers. Useful polymeric materials for making such supports include, but are not limited to, polyesters (such as polyethylene terephthalate and polyethylene naphthalate), cellulose acetate and other cellulose esters, polyvinyl acetal, polyolefins (such as polyethylene and polypropylene), polycarbonates, and polystyrenes (and polymers of styrene derivatives). Preferred supports are composed of polymers having good heat stability, such as polyesters and polycarbonates. Polyethylene terephthalate film is a particularly preferred support. Various support materials are described, for example, in Research Disclosure, August 1979, item 18431. A method of making dimensionally stable polyester films is described in Research Disclosure, September 1999, item 42536.

Opaque supports can also be used, such as dyed polymeric films and resin-coated papers that are stable to high temperatures.

Support materials can contain various colorants, pigments, and antihalation or acutance dyes if desired. For example, the support can contain conventional blue dyes that differ in absorbance from colorants in the various frontside or backside layers, for example as described in U.S. Pat. No. 6,248,442 (Van Achere et al.). Support materials may be treated using conventional procedures (such as corona discharge) to improve adhesion of overlying layers, or subbing or other adhesion-promoting layers can be used. Useful subbing layer formulations include those conventionally used for photographic materials such as vinylidene halide polymers.

Support materials may also be treated or annealed to reduce shrinkage and promote dimensional stability.

Thermographic Formulations

An organic-based formulation for the thermographic emulsion layer(s) can be prepared by dissolving and dispersing the binder, the source of non-photosensitive silver ions, the reducing agent composition, toner(s), and optional addenda in an organic solvent, such as toluene, 2-butanone (methyl ethyl ketone), acetone, or tetrahydrofuran.

Thermographic materials of the invention can contain plasticizers and lubricants such as poly(alcohols) and diols of the type described in U.S. Pat. No. 2,960,404 (Milton et al.), fatty acids or esters such as those described in U.S. Pat. No. 2,588,765 (Robijns) and U.S. Pat. No. 3,121,060 (Duane), and silicone resins such as those described in GB 955,061 (DuPont). The lubricants can be in any of the layers, but preferably they are in the outermost conductive layer(s). Both solid and liquid lubricants can be used, and in some embodiments, it is desirable to provide one or more of each type of lubricant, especially in the outermost conductive layer to provide maximum “slip” of the outermost layer against the imaging source such as thermal heads. Thus, it is desirable to reduce the dynamic coefficient of friction as low as possible as described for example in U.S. Pat. No. 5,817,598 (Defieuw et al.) using various surface active agents, lubricants (such as fatty acid derivatives, silicon derivatives, polyolefins, fatty alcohol derivatives, and phosphoric acid derivatives).

The materials can also contain matting agents such as starch, titanium dioxide, zinc oxide, silica, and polymeric beads including beads of the type described in U.S. Pat. No. 2,992,101 (Jelley et al.) and U.S. Pat. No. 2,701,245 (Lynn). The matting agents can be in any of the layers but preferably they are in the outermost conductive layer and may have a size in relation to the layer thickness that enables them to protrude through the outer surface of the conductive layer, as described for example, in U.S. Pat. No. 5,536,696 (Horsten et al.).

Polymeric fluorinated surfactants may also be useful in one or more layers of the thermographic materials for various purposes, such as improving coatability and optical density uniformity as described in U.S. Pat. No. 5,468,603 (Kub).

The thermographic materials of this invention can be constructed of one or more layers on the imaging side of the support. Single layer materials should contain the non-photosensitive source of reducible silver ions, the reducing agent composition, the binder, as well as optional materials such as toners, acutance dyes, coating aids, and other adjuvants. An outermost conductive layer can be used on the backside of the support in these embodiments.

Two-layer constructions comprising a single imaging layer coating containing all the ingredients and a surface protective topcoat are generally found on the frontside of the materials of this invention. However, two-layer constructions containing non-photosensitive source of reducible silver ions in one imaging layer (usually the layer adjacent to the support) and the reducing agent composition and other ingredients in the second imaging layer or distributed between both layers are also envisioned. Alternatively, the outermost conductive layer described herein can also be used as the surface protective layer. An outermost conductive layer can also be used on the backside of the support in these embodiments.

Layers to promote adhesion of one layer to another in thermo-graphic materials are also known, as described for example in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described for example in U.S. Pat. No. 5,928,857 (Geisler et al.).

Layers to reduce emissions from the film may also be present, including the polymeric barrier layers described in U.S. Pat. No. 6,352,819 (Kenney et al.), U.S. Pat. No. 6,352,820 (Bauer et al.), U.S. Pat. No. 6,420,102B1 (Bauer et al.), and in copending and commonly assigned U. S. Serial No. 10/351,814 (filed Jan. 27, 2003 by Hunt), all incorporated herein by reference.

Thermographic layer formulations described herein can be coated by various coating procedures including wire wound rod coating, dip coating, air knife coating, curtain coating, slide coating, or extrusion coating using hoppers of the type described in U.S. Pat. No. 2,681,294 (Beguin). Layers can be coated one at a time, or two or more layers can be coated simultaneously by the procedures described in U.S. Pat. No. 2,761,791 (Russell), U.S. Pat. No. 4,001,024 (Dittman et al.), U.S. Pat. No. 4,569,863 (Keopke et al.), U.S. Pat. No. 5,340,613 (Hanzalik et al.), U.S. Pat. No. 5,405,740 (LaBelle), U.S. Pat. No. 5,415,993 (Hanzalik et al.), U.S. Pat. No. 5,525,376 (Leonard), U.S. Pat. No. 5,733,608 (Kessel et al.), U.S. Pat. No. 5,849,363 (Yapel et al.), U.S. Pat. No. 5,843,530 (Jerry et al.), U.S. Pat. No. 5,861,195 (Bhave et al.), and GB 837,095 (Ilford). A typical coating gap for the emulsion layer can be from about 10 to about 750 pim, and the layer can be dried in forced air at a temperature of from about 20° C. to about 100° C. It is preferred that the thickness of the layer be selected to provide maximum image densities greater than about 0.2, and more preferably, from about 0.5 to 5.0 or more, as measured by a MacBeth Color Densitometer Model TD 504.

When the layers are coated simultaneously using various coating techniques, a “carrier” layer formulation comprising a single-phase mixture of the two or more polymers described above may be used. Such formulations are described in U.S. Pat. No. 6,436,622 (Geisler), incorporated herein by reference.

Mottle and other surface anomalies can be reduced in the materials of this invention by incorporation of a fluorinated polymer as described for example in U.S. Pat. No. 5,532,121 (Yonkoski et al.) or by using particular drying techniques as described, for example in U.S. Pat. No. 5,621,983 (Ludemann et al.).

Preferably, two or more layers are applied to a film support using slide coating. The first layer can be coated on top of the second layer while the second layer is still wet. The first and second fluids used to coat these layers can be the same or different solvents (or solvent mixtures).

I While the first and second layers can be coated on one side of the film support, manufacturing methods can also include forming on the opposing or backside of said polymeric support, one or more additional layers, including an outermost conductive layer.

Antistatic Compositions/Layers

The essential feature of the present invention is the presence of a conductive layer as the outermost layer on either or both sides of the support. The conductive layer includes one or more specific non-acicular metal antimonate particles having a composition represented by the following Structure I or II:

M⁺²Sb⁺⁵₂O₆ (I)

wherein M is zinc, nickel, magnesium, iron, copper, manganese, or cobalt,

Mₐ⁺³Sb⁺⁵O₄ (II)

wherein Mₐ is indium, aluminum, scandium, chromium, iron, or gallium.

Thus, these particles are generally metal oxides that are doped with antimony.

Preferably, the non-acicular metal antimonate particles are composed of ZnSb₂O₆. Several conductive metal antimonates are commercially available from Nissan Chemical Industry, Ltd. (Japan) including the preferred ZnSb₂O₆ non-acicular particles that are available as a 40% (solids) solution under the tradename CELNAX® 401M.

Alternatively, the metal antimonate particles can be prepared using methods described for example in U.S. Pat. No. 5,457,013 (noted above) and references cited therein.

The metal antimonate particles in the conductive layer are predominately (more than 50% by weight of total particles) in the form of non-acicular particles as opposed to “acicular” particles. By “non-acicular” particles is meant not needlelike, that is, not acicular. Thus, the shape of the metal antimonate particles can be granular, spherical, ovoid, cubic, rhombic, tabular, tetrahedral, octahedral, icosahedral, truncated cubic, truncated rhombic, or any other non-needle like shape.

Generally, these metal particles have an average diameter of from about 15 to about 20 nm as measured across the largest particle dimension using the BET method.

The non-acicular metal antimonate particles generally comprise from about 40 to about 55% (preferably from about 40 to about 50%) by weight of the conductive layer. Another way of defining the amount of particles is that they are generally present in the conductive layer in an amount of from about 0.05 to about 3 g/m² and preferably in an amount of from about 0.15 to about 2 g/m². Mixtures of different types of non-acicular metal antimonate particles can be used if desired.

The non-acicular metal antimonate particles are also generally present in an amount sufficient to provide a static decay time of 120 seconds or less (preferably 25 seconds or less) as measured using the techniques and procedures described below in the examples.

An essential aspect of the present invention is the fact that the conductive metal antimonate particles are present in one or more outermost conductive layers on either or both sides of the support, meaning that there are no other layers disposed over the conductive layer(s). The conductive metal antimonate particles can be homogeneously distributed throughout the conductive layer, or they can be dispersed in regions of the layer. For example, they can be dispersed in a region nearest the outermost surface to improve the physical properties of the surface with a minimum amount of particles. In this way, a “sub-layer” of particles can be provided with one or more other sub-layers that are free of particles, and all of the sub-layer composing the entire conductive layer.

The outermost conductive layer has a dry thickness of at least 0.1 μm, and preferably a dry thickness of from about 0.4 to about 4 μm.

The conductive layer is generally coated out of one or more miscible organic solvents including, but not limited to, methyl ethyl ketone (2-butanone, MEK), acetone, toluene, tetrahydrofuran, ethyl acetate, ethanol, methanol, or any mixture of any two or more of these solvents.

As noted above, the conductive layer also includes one or more binder materials that are usually polymers that are generally soluble or dispersible in the organic solvents noted above. Representative polymers can be chosen from one or more of the following classes: polyvinyl acetals (such as polyvinyl butyral, polyvinyl acetal, and polyvinyl formal), cellulosic ester polymers (such as cellulose acetate, cellulose diacetate, cellulose triacetate, cellulose acetate propionate, hydroxymethyl cellulose, cellulose nitrate, and cellulose acetate butyrate), polyesters, polycarbonates, epoxies, rosin polymers, polyketone resin, vinyl polymers (such as polyvinyl chloride, polyvinyl acetate, polystyrene, polyacrylonitrile, and butadiene-styrene copolymers), acrylate and methacrylate polymers, and maleic anhydride ester copolymers. The polyvinyl acetals, polyesters, cellulosic ester polymers, and vinyl polymers such as polyvinyl acetate and polyvinyl chloride are particularly preferred, and the polyvinyl acetals, polyesters, and cellulosic ester polymers are more preferred.

As used herein for all polymeric materials, the term “polymer” is defined to include homopolymers, copolymers, interpolymers, and terpolymers.

The polymers in the conductive layer generally comprise at least 0.1 weight % (preferably at least 0.2 weight %) of the total wet coating weight of the layer. The maximum amount of such polymers is generally 40 weight %, and preferably up to 20 weight %, based on total wet coating weight.

Other components of the conductive layer include materials that may improve coatability or adhesion, crosslinking agents (such as diisocyanates), surfactants, and shelf-aging promoters. The conductive layer may also include other addenda commonly added to such formulations including, but not limited to, shelf life extenders, colorants to control tint and tone, UV absorbing materials, to improve light-box stability, and coating aids such as surfactants to achieve high quality coatings, all in conventional amounts. It is also useful to add inorganic matting agents such as talc particles, the polysilicic acid particles as described in U.S. Pat. No. 4,828,971 (Przezdziecki), poly(methyl methacrylate) beads as described in U.S. Pat. No. 5,310,640 (Markin et al.), or polymeric cores surrounded by a layer of colloidal inorganic particles as described in U.S. Pat. No. 5,750,328 (Melpolder et al.). As noted above, the matting agents can be sized to protrude through the surface of the outermost conductive layer. In general, the matting agents are present in the outermost conductive layer(s) in an amount of from about 0.2 to about 4% (total dry layer weight).

It may also be useful to include one or more lubricants in the outermost conductive layer(s). Solid or liquid lubricants or combinations thereof are suitable for improving the “slip” characteristics of the thermographic materials during transport and imaging. Solid lubricants include, but are not limited to, polyolefin waxes, ester waxes, polyolefin-polyether block copolymers, amide waxes, polyglycols, fatty acids, fatty alcohols, natural waxes, and solid phosphoric acid derivatives. Details about useful lubricants are provided in U.S. Pat. No. 5,817,598 (noted above). In addition, thermomeltable particles as described in WO 94/11199 (Horsten et al.) can be used.

Liquid lubricants that can be used include, but are not limited to, fatty acid esters such as glycerine trioleate, sorbitan monooleate and sorbitan trioleate, silicone oil derivatives, and phosphoric acid derivatives.

The thermographic materials of this invention can also include one or more antistatic or conductive layers containing other conductive materials on either side of the support if desired. Such layers may contain conventional antistatic agents known in the art for this purpose such as soluble salts (for example, chlorides or nitrates), evaporated metal layers, or ionic polymers such as those described in U.S. Pat. No. 2,861,056 (Minsk) and U.S. Pat. No. 3,206,312 (Sterman et al.), insoluble inorganic salts such as those described in U.S. Pat. No. 3,428,451 (Trevoy), electroconductive underlayers such as those described in U.S. Pat. No. 5,310,640 (Markin et al.), and electrically-conductive metal-containing particles dispersed in a polymeric binder such as those described in EP 0 678 776A1 (Melpolder et al.). In addition, fluorochemicals such as Fluorado FC-135 (3M Corporation), ZONYL FSN (E. I. DuPont de Nemours & Co.), as well as those described in U.S. Pat. No. 5,674,671 (Brandon et al.), U.S. Pat. No. 6,287,754 (Melpolder et al.), U.S. Pat. No. 4,975,363 (Cavallo et al.), U.S. Pat. No. 6,171,707 (Gomez et al.), in copending and commonly assigned U.S. Ser. No. 10/107,551 (filed March 27, 2002 by Sakizadeh, LaBelle, Orem, and Bhave), and in copending and commonly assigned U.S. Ser. No. 10/265,058 (filed Oct. 10, 2002 by Sakizadeh, LaBelle, and Bhave) can be used.

Imaging/Development

The thermographic materials of the present invention can be imaged in any suitable manner consistent with the type of material using any suitable source of thermal energy. The image may be “written” simultaneously with development at a suitable temperature using a thermal stylus, a thermal print head, or a laser, or by heating while in contact with a heat-absorbing material. The thermographic materials may include a dye (such as an IR-absorbing dye) to facilitate direct development by exposure to laser radiation. The dye converts absorbed radiation to heat.

Use as a Photomask

The thermographic materials of the present invention are sufficiently transmissive in the range of from about 350 to about 450 nm in non-imaged areas to allow their use in a method where there is a subsequent exposure of an ultraviolet or short wavelength visible radiation sensitive imageable medium. For example, imaging the materials affords a visible image. The thermographic materials absorb ultraviolet or short wavelength visible radiation in the areas where there is a visible image and transmit ultraviolet or short wavelength visible radiation where there is no visible image. The materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate. Exposing the imageable material to the imaging radiation through the visible image in the thermographic material provides an image in the imageable material. This method is particularly useful where the imageable medium comprises a printing plate and the thermographic material serves as an imagesetting film.

Thus, the present invention provides a method for the formation of a visible image (usually a black-and-white image) by thermal imaging of the inventive thermographic material. In one embodiment, the present invention provides a method comprising:

A) thermal imaging of the thermographic material of this invention (having a transparent support) to form a visible image,

B) positioning the imaged thermographic material between a source of imaging radiation and an imageable material that is sensitive to the imaging radiation, and

C) exposing the imageable material to the imaging radiation through the visible image in the imaged thermographic material to provide an image in the imageable material.

The following examples are provided to illustrate the practice of the present invention and the invention is not meant to be limited thereby.

Materials and Methods for the Experiments and Examples:

All materials used in the following examples are readily available from standard commercial sources, such as Aldrich Chemical Co. (Milwaukee Wisconsin) unless otherwise specified. All percentages are by weight unless otherwise indicated. The following additional terms and materials were used.

ALBACAR 5970 is a 1.9 μm precipitated calcium carbonate. It is available from Specialty Minerals, Inc. (Bethlehem, Pa.).

BUTVAR® B-79 is a polyvinyl butyral resin available from Solutia, Inc. (St. Louis, Mo.).

CAB 171-15S and CAB 381-20 are cellulose acetate butyrate resins available from Eastman Chemical Co. (Kingsport, Tenn.).

CELNAX® CX-Z401M is a 40% organosol dispersion of non-acicular zinc antimonate particles in methanol. It was obtained from Nissan Chemical America Corporation (Houston, Tex.).

Dow Coming 550 (DC-550) is a trimethyl terminated dimethyl, phenylmethyl siloxane available from Dow Coming (Midland, Mich.).

MEK is methyl ethyl ketone (or 2-butanone).

PARALOID® A-21 is an acrylic copolymer available from Rohm and Haas (Philadelphia, Pa.).

PIOLOFORM® BL-16 is a polyvinyl butyral resin available from Wacker Polymer Systems (Adrian, Mich.).

SERVOXYL® VPAZ 100 is a mixture of monolauryl and dilauryl esters of phosphoric acid. It is available from Sasol North America (Houston, Tex.).

VITEL® PE 5833B is a polyester resin available from Bostik, Inc. (Middleton, Mass.).

Resistivity Measurements:

Resistivity of conductive coatings was measured using the “Static Decay Time” test. In this test, an ETS Model 406D Static Decay Meter. It is available from Electro-Tech Systems Inc. (Glenside, Pa.) was used to determine the rate of static charge decay on a sample. The sample is subjected to a fixed voltage to induce an electrostatic charge on its surface. The charge is then dissipated (bled off) by providing a path for current flow to ground. The time for the charge to dissipate to 10% of its initial value is recorded.

Decay times were measured in a room maintained at 70° F. (21.1° C.)/20% relative humidity (RH) unless otherwise specified. All testing was done after samples had been acclimated for at least 18 hours. A +5 kV charge was applied and the time to reach 10% of the charge (90% decay) was recorded. Samples that demonstrate poor antistatic properties do not dissipate charge and their decay times are reported as “not conductive.” In order to function as an antistatic material, a compound should provide a coating having a decay time of less than 25 seconds and preferably less than 5 seconds at a temperature of 70° F. (21.1° C.) and a relative humidity of 20%.

Deformation Measurements:

Thermal Mechanical Analysis (TMA) is a method of determining the ease of deformation (that is, hardness) of a material. The hardness of the conductive coatings was measured using a TA Model 2940 Thermomechanical Analyzer. It is available from TA Instruments Inc. (New Castle, Del.). A sample approximately 0.5 mm square was heated under a stylus with a force of 0.08N and a heating rate of 20° C. per minute. Samples were heated from 20° C. to 180° C. and then cooled down 20° C. These temperatures are believed to be similar to those encountered in a thermal printer

Adhesion Measurements:

Adhesion of the conductive coatings to the support was evaluated by scribing a small cross-hatched region into the coating with a razor blade. A piece of high tack transparent tape was placed over the scribed region and quickly removed form the coating. The relative amount of coating removed is a qualitative measure of the adhesion of the coating to the support.

Densitometry Measurements:

Densitometry measurements were carried out on an X-Rite® Model 301 densitometer that is available from X-Rite Inc. (Grandville, Mich.).

The following examples demonstrate the use of the antistatic materials of the invention in a thermographic material.

### Examples 1-3

### Thermographic Material having Conductive Backside Surface Layer

Three thermographic materials (film Examples 1-3) of the present invention and a Control A film were prepared and evaluated as follows.

Silver Soap Homogenate Formulation:

A silver soap thermographic homogenate formulation was prepared with the following components.

| | |
|---|---|
| MEK | 75.5 parts |
| Silver Behenate | 24.0 parts |
| PIOLOFORM ® BL-16 | 0.5 parts |

The materials were mixed and homogenized by passing twice through a homogenizer at 5000 psi (352 kg/cm²). The materials were cooled between the two passes.

Thermographic Emulsion Formulation:

To 24.74 g of the silver behenate homogenate at 24.5% solids was added 2.77 g of MEK, 0.96 g of phthalazinone, 1.71 g of 2,3-dihydroxybenzoic acid, and a solution of 20.9 g of BUTVAR® B-79 in 48.9 g of MEK. The mixture was stirred for 10 minutes to dissolve the materials.

Thermographic Layer Topcoat Formulation:

A topcoat formulation was prepared for application over the thermographic emulsion formulation with the following components:

| | |
|---|---|
| MEK | 83.72 parts |
| CAB 171-15S | 12.14 parts |
| PARALOID A-21 | 1.65 parts |
| DC 550 | 2.00 parts |
| SERVOXYL ® VPAZ 100 | 0.26 parts |
| ALBACAR 5970 | 0.23 parts |

The resulting topcoat solution contained 14.3% solids and had a viscosity of 1000 centipoise.

The thermographic emulsion and topcoat formulations were coated onto a 7 mil (178 μm) blue tinted polyethylene terephthalate support using a conventional, laboratory scale, dual-knife coater. Samples were dried in an oven at 200° F. (93.3° C.) for 3.5 minutes. The coating weight of the thermographic emulsion layer was 2.0 g/ft² (21.5 g/m²). The coating weight of the topcoat layer was 0.4 gift² (4.3 g/m²)

Conductive Backside Surface Layer Formulation:

Backside conductive layer formulations were prepared with the materials shown below in TABLE I. All amounts are in parts by weight. Each backside layer formulation was then coated onto the side of the support opposite to that containing the thermographic coating using a conventional knife coater to provide materials having the dry coat weights indicated. Control A contained no CELNAX® CX-Z401M. It served as a control.

TABLE I

| | CELNAX ® | | CAB | VITEL ® | Dry Coat |
|---|---|---|---|---|---|
| Film | CX-Z401M | MEK | 381-20 | PE 5833 | Weight |
| Example 1 | 7.5 parts | 83.5 parts | 7.5 parts | 1.5 parts | 0.42 g/ft² |
| | | | | | (4.5 g/m²) |
| Example 2 | 7.5 parts | 83.5 parts | 7.5 parts | 1.5 parts | 0.25 g/ft² |
| | | | | | (2.7 g/m²) |
| Example 3 | 10 parts | 81 parts | 7.5 parts | 1.5 parts | 0.29 g/ft² |
| | | | | | (3.1 g/m²) |
| Control A | 0 parts | 91 parts | 7.5 parts | 1.5 parts | 0.35 g/ft² |
| | | | | | (3.8 g/m²) |

Samples of the thermographic materials were stored in a black polyethylene bag at 70° F. (21.1° C.) and 20% RH for 24 hours. Adhesion, resistivity, and thermal mechanical analysis were then measured using techniques described above.

The results, shown below in TABLE II, demonstrate that the adhesion, antistatic, and deformation properties of the thermographic materials of the present invention have been improved by incorporation of the CELNAX® CX-Z401M particles into the conductive backside surface layer.

TABLE II

| | | TMA (deformation | Decay |
|---|---|---|---|
| Film | Adhesion | in microns) | Time |
| Example 1 | Good | 1 μm | 0.13 sec |
| Example 2 | Good | — | 100 sec |
| Example 3 | Excellent | — | 0.10 sec |
| Control A | Poor | 6 μm | >3 hr |

Samples of the resulting thermographic materials were imaged using an AGFA DryStar™ Model 2000 printer. A test pattern was used. All samples gave several levels of gray and a black image. The results, shown below in TABLE V demonstrate that thermographic materials incorporating non-acicular particles in a backside surface layer have low Dₘᵢₙ and high Dₘₐₓ.

TABLE III

| Film | Dₘᵢₙ | Dₘₐₓ |
|---|---|---|
| Example 2 | 0.16 | 3.54 |
| Example 3 | 0.15 | 3.60 |
| Control A | 0.15 | 3.63 |

### Examples 4 & 5

### Thermographic Material having Conductive Frontside Surface Layer

Two thermographic materials (film Examples 4 and 5) and a Control B film were prepared and evaluated as follows.

Thermographic Emulsion Formulation:

To 22.2 g of the silver behenate homogenate prepared in Example 1, was added a solution of 65 g of MEK, 0.61 g of phthalazinone, 1.01 g of VITEL® PE 5833, 1.09 g of 2,3-dihydroxybenzoic acid, and 10.13 g of CAB 171-15S. The mixture was then stirred for 10 minutes to completely dissolve the materials.

Conductive Frontside Surface Layer Formulation:

A conductive frontside surface layer formulation was prepared for application over the thermographic emulsion formulation with the following components:

| | |
|---|---|
| CELNAX ® CX-Z401M | 20.07 parts |
| MEK | 67.26 parts |
| CAB 171-15S | 10.18 parts |
| DC 550 | 2.00 parts |
| SERVOXYL ® VPAZ 100 | 0.26 parts |
| ALBACAR 5970 | 0.23 parts |

The resulting conductive frontside surface layer formulation contained 18.7% solids and had a viscosity of 1000 centipoise.

Example 4: The Example 4 film was prepared by coating the thermographic emulsion and conductive frontside surface layer formulations onto a 7 mil (178 μm) blue tinted polyethylene terephthalate support using a conventional, laboratory scale, dual-knife coater. The sample was dried in an oven at 200° F. (93.3° C.) for 3.5 minutes. The coating weight of the thermographic emulsion layer was 1.7 g/ft² (18.3 g/m²). The coating weight of the conductive frontside surface layer was 0.4 g/ft² (4.3 g/m²).

Example 5: The Example 5 film was prepared by coating the thermographic layer, an intermediate layer, and a conductive frontside surface layer. The intermediate layer formulation contained the following materials:

Intermediate Layer Formulation:

| | |
|---|---|
| MEK | 87.33 parts |
| CAB 171-15S | 10.18 parts |
| DC 550 | 2.00 parts |
| SERVOXYL ® VPAZ 100 | 0.26 parts |
| ALBACAR 5970 | 0.23 parts |

The thermographic emulsion was coated as a single layer onto a 7 mil (178 μm) blue tinted polyethylene terephthalate support using a conventional, laboratory scale, knife coater. The sample was dried in an oven at 200° F. (93.3° C.) for 3.5 minutes. The dry coating weight of the thermographic layer was 1.7 g/ft² (18.3 g/m²).

The intermediate layer formulation and conductive frontside surface layer formulation were coated on top of the thermographic layer using a conventional, laboratory scale, dual knife coater. The construction was again dried in an oven at 200° F. (93.3° C.) for 3.5 minutes. The coating weight of the intermediate layer was 0.35 g/ft² (3.8 g/m²). The coating weight of the conductive frontside surface layer containing CELNAX® CX-Z401M was 0.04 g/ft² (0.43 g/m²). This is a thinner layer than that of Example 4.

Control B: This film was prepared by coating only the thermo-graphic layer and intermediate layer. Thus, this sample had no conductive frontside surface layer. The intermediate layer served as a non-conductive surface (topcoat) layer. The thermographic emulsion and intermediate layer formulations were coated onto a 7 mil (178 μm) blue tinted polyethylene terephthalate support using a conventional, laboratory scale, dual-knife coater. The sample was dried in an oven at 200° F. (93.3° C.) for 3.5 minutes. The coating weight of the thermo-graphic emulsion layer was 1.7 g/ft² (18.3 g/m²). The coating weight of the surface layer was 0.4 g/ft² (4.3 g/m²). This sample served as a control.

Decay times were measured using the “Static Decay Time” method described above. The results, shown below in TABLE IV, demonstrate that incorporation of non-acicular metal antimonate particles dispersed in a hydrophobic binder on the outer frontside surface provide thermographic materials with excellent antistatic properties.

Samples of the resulting thermographic materials were imaged using an AGFA DryStar™ Model 2000 printer. A test pattern was used. All samples gave several levels of gray and a black image. The results, shown below in TABLE V demonstrate that thermographic materials incorporating non-acicular particles in a frontside surface layer have low Dₘᵢₙ and high Dₘₐₓ.

TABLE IV

| Film | Decay Time | Dₘᵢₙ | Dₘₐₓ |
|---|---|---|---|
| Example 4 | 0.1 sec | 0.16 | 2.34 |
| Example 5 | 1 sec | 0.15 | 2.24 |
| Control B | >3 hr | — | — |

### Example 6

### Thermographic Material having Conductive Topcoat Surface Layer

Still another thermographic material (Film Example 6) and a Control C film were prepared and evaluated as follows.

Thermographic Emulsion Formulation:

To 24.74 g of the silver behenate homogenate prepared in Example 1, was added 2.77 g of MEK, 0.96 g of phthalazinone, 1.71 g of 2,3-dihydroxybenzoic acid, and a solution of 20.9 g of BUTVAR® B-79 in 48.9 g of MEK. The mixture was stirred for 10 minutes to dissolve the materials.

Example 6: A conductive frontside surface layer formulation was prepared for application over the thermographic emulsion formulation with the following components:

| | |
|---|---|
| CELNAX ® CX-Z401M | 20.07 parts |
| MEK | 67.26 parts |
| CAB 171-15S | 10.18 parts |
| DC 550 | 2.00 parts |
| SERVOXYL ® VPAZ 100 | 0.26 parts |
| ALBACAR 5970 | 0.23 parts |

The resulting conductive frontside surface layer formulation contained 18.7% solids and had a viscosity of 1000 centipoise.

The thermographic emulsion and topcoat formulations were coated onto a 7 mil (178 μm) blue tinted polyethylene terephthalate support using a conventional, laboratory scale, dual-knife coater. Samples were dried in an oven at 200° F. (93.3° C.) for 3.5 minutes. The coating weight of the thermographic emulsion layer was 2.0 g/ft² (21.5 g/m²). The coating weight of the topcoat layer was 0.4 g/ft² (4.3 g/m²).

Control C: A control topcoat formulation was prepared for application over the thermographic emulsion formulation with the following components:

| | |
|---|---|
| MEK | 83.72 parts |
| CAB 171-15S | 12.14 parts |
| PARALOID A-21 | 1.65 parts |
| DC 550 | 2.00 parts |
| SERVOXYL ® VPAZ 100 | 0.26 parts |
| ALBACAR 5970 | 0.23 parts |

The resulting topcoat solution contained 14.3% solids and had a viscosity of 1000 centipoise.

The thermographic emulsion and topcoat formulations were coated onto a 7 mil (178 μm) blue tinted polyethylene terephthalate support using a conventional, laboratory scale, dual-knife coater. Samples were dried in an oven at 200° F. (93.3° C.) for 3.5 minutes. The coating weight of the thermographic emulsion layer was 2.0 g/ft² (21.5 g/m²). The coating weight of the topcoat layer was 0.4 g/ft² (4.3 g/m²).

Decay times were again measured using the “Static Decay Time” method described above. The results, shown below in TABLE V, demonstrate that incorporation of non-acicular metal antimonate particles dispersed in a hydrophobic binder on the outer frontside surface provide thermographic materials with excellent antistatic properties.

Samples of the resulting thermographic materials were imaged using an AGFA DryStar™ Model 2000 printer. A test pattern was used. All samples gave several levels of gray and a black image. The results, shown below in TABLE V demonstrate that thermographic materials incorporating non-acicular particles in a frontside surface layer have low Dₘᵢₙ and high Dₘₐₓ.

Samples of the resulting thermographic materials were also subjected to Thermomechanical analysis. The results, shown below in TABLE V demonstrate that thermographic materials incorporating non-acicular particles in a frontside surface layer have harder and have greater resistance to deformation than similarly prepared frontside surface layers not incorporating such particles.

TABLE V

| | | | Decay | TMA |
|---|---|---|---|---|
| Film | Dₘᵢₙ | Dₘₐₓ | Time | Deformation |
| Example 6 | 0.19 | 3.65 | 0.1 sec | 32 μm |
| Control C | 0.18 | 3.38 | 160 sec | 38 μm |

The invention has been described in detail with particular reference to certain preferred embodiments thereof, but it will be understood that variations and modifications can be effected within the spirit and scope of the invention.

I claim:

1. A non-photosensitive thermographic material consisting essentially of a polymer support and on one or both sides thereof, one or more thermally sensitive imaging layers and an outermost non-thermally sensitive, conductive layer over said one or more thermally sensitive imaging layers,
said one or more thermally sensitive layers having in reactive association, a non-photosensitive source of reducible silver ions and a reducing agent composition for said reducible silver ions, and
said outermost non-thermally sensitive, conductive layer being an organic solvent-based conductive layer comprising non-acicular metal antimonate particles dispersed in a hydrophobic binder in an amount of at least 10 weight %.

2. The thermographic material of claim 1 wherein said conductive layer has a dry thickness of from about 0.4 to about 4 μm.

3. The thermographic material of claim 1 wherein said conductive layer further comprises a lubricant.

4. The thermographic material of claim 3 wherein said conductive layer further comprises both a solid and a liquid lubricant.

5. The thermographic material of claim 1 wherein said conductive layer further comprises a matting agent that comprises from about 0.2 to about 4 dry weight % of said conductive layer.

6. The thermographic material of claim 1 wherein said non-photosensitive source of reducible silver ions includes one or more silver carboxylates, one of which is silver behenate.

7. The thermographic material of claim 6 wherein said non-photosensitive source of reducible silver ions includes highly crystalline silver behenate.

8. The thermographic material of claim 1 wherein said reducing agent composition comprises an aromatic di- or trihydroxy compound or a hindered phenol.

9. The thermographic material of claim 1 wherein said non-acicular metal antimonate particles comprise from about 40 to about 55% of the dry weight of said conductive layer.

10. The thermographic material of claim 1 wherein said non-acicular metal antimonate particles are present in said conductive layer in an amount of from about 0.05 to about 3 g/m².

11. The thermographic material of claim 1 wherein said non-acicular metal antimonate particles are present in said conductive layer in an amount sufficient to provide a static decay time of 25 seconds or less.

12. The thermographic material of claim 1 wherein said non-acicular metal antimonate particles have a composition represented by the following Structure I or II:
M⁺²Sb⁺⁵₂O₆ (I)
wherein M is zinc, nickel, magnesium, iron, copper, manganese, or cobalt,
Mₐ⁺³Sb⁺⁵O₄ (II)
wherein Mₐ is indium, aluminum, scandium, chromium, iron, or gallium.

13. The thermographic material of claim 1 wherein said non-acicular metal antimonate particles are composed of ZnSb₂O₆.

14. A black-and-white, non-photosensitive thermographic material that consists essentially of a transparent polymer support having on one or both sides thereof one or more thermally sensitive imaging layers and an outermost non-thermally sensitive conductive layer over said one or more thermally sensitive imaging layers,
said one or more thermally sensitive imaging layers comprising predominantly one or more hydrophobic binders that is either polyvinyl butyral or a cellulose acetate polymer, and in reactive association, a non-photosensitive source of reducible silver ions that includes one or more silver aliphatic carboxylates at least one of which is highly crystalline silver behenate, a reducing agent composition for said non-photosensitive source reducible silver ions comprising an aromatic di- and tri-hydroxy compound having at least two hydroxy groups in ortho- or para-relationship on the same aromatic nucleus or mixture thereof, and
said outermost conductive layer comprising either polyvinyl butyral or a cellulosic ester polymer and dispersed therein non-acicular metal antimonate particles are composed of ZnSb₂O₆ and comprise from about 40 to about 50% of the dry weight of said conductive layer and are present in said conductive layer in an amount of from about 0.15 to about 2 g/m².

15. The thermographic material of claim 14 wherein said non-acicular metal antimonate particles composed of ZnSb₂O₆ are present in said conductive layer in an amount sufficient to provide a static decay time of 5 seconds or less.

16. The thermographic material of claim 14 comprising an outermost conductive layer on both sides of said support.

17. The thermographic material of claim 14 comprising thermally sensitive imaging layers on only one side of said support.

18. A method comprising imaging the thermographic material of claim 1 with a thermal imaging source to provide a visible image.

19. The method of claim 18 wherein said thermographic material comprises a transparent support and said image-forming method further comprises:
positioning said imaged thermographic material with the visible image thereon between a source of imaging radiation and an imageable material that is sensitive to said imaging radiation, and
thereafter exposing said imageable material to said imaging radiation through the visible image in said imaged thermographic material to provide an image in said imageable material.

20. A method comprising imaging the thermographic material of claim 14 with a thermal imaging source to provide a visible image.

21. The method of claim 20 wherein said imaging is carried out using a thermal head and said thermographic material is moved in contact with and relative to said thermal head.

22. The method of claim 18 wherein the imaged thermographic material is used for medical diagnostic purposes.
